(19) United States
(12) Patent Application Publication
(10) Pub. No.: US 2010/0077998 A1
(43) Pub. Date: Apr. 1, 2010

(54) TURBOCHARGER BOOSTER SYSTEM

(75) Inventors: Kirby Chapman, Manhattan, KS (US); Kyle Wolfram, Kingwood, TX (US); Eric Figge, Manhattan, KS (US)

Correspondence Address: HOVEY WILLIAMS LLP, 10801 Mastin Blvd., Suite 1000, Overland Park, KS, 66210, US

(73) Assignee: Kansas State University Research Foundation, Manhattan, KS (US)

(21) Appl. No.: 12/243,833

(22) Filed: Oct. 1, 2008

(51) Int. Cl. F02B 33/00

(52) U.S. Cl. 123/564; 60/611

(57) ABSTRACT

A turbocharged engine includes an internal combustion engine and a turbocharger powered by engine exhaust flow from the internal combustion engine to supply the engine with compressed intake air. The turbocharged engine further includes a turbocharger booster system with a dry low emissions burner. The burner fluidly communicates with an exhaust manifold of the engine and is operable to inject a combustion gas flow into the engine exhaust flow. The hot combustion gas flow is operable to increase the exhaust energy available to the turbocharger and thereby increase the output of compressed intake air.

### CROSS REFERENCE TO RELATED APPLICATION

This application is being filed contemporaneously with application for U.S. Letters Patent Ser. No. ______, entitled ACTIVE AIR CONTROL, and application for U.S. Letters Patent Ser. No. ______, entitled VARIABLE GEOMETRY TURBOCHARGER, both of which are hereby incorporated in their entirety by reference herein.

### BACKGROUND

1. Field

The present invention relates generally to turbochargers for internal combustion engines. More specifically, embodiments of the present invention concern a turbocharger and a booster system operable to increase the compressed air flow discharged by the turbocharger.

2. Discussion of Prior Art

Turbochargers are commonly used to improve the performance of reciprocating internal combustion engines. Prior art turbochargers include a turbine, which is powered by energy available from engine exhaust, and a compressor driven by the turbine to provide a compressed charge of intake air to the engine. It is well known for turbochargers to have operating characteristics matched with a corresponding engine so that efficient turbocharger operation occurs over a range of engine load or engine speed. For instance, the turbine or compressor of the turbocharger can be sized for a particular engine. Also, turbochargers often employ a wastegate to vent exhaust air or intake air. Furthermore, it is known for a turbocharger to have features with variable geometry to adjust the operating performance.

While the prior art features permit turbocharger matching, prior art turbochargers suffer from various limitations. For example, turbochargers generally cannot provide enough intake air to the engine under the full range of typical ambient conditions, particularly under very hot ambient temperatures. Turbochargers also are unable to provide sufficient intake air when the engine is operating under off-design conditions and when performance of the turbocharger itself has significantly degraded.

### SUMMARY

Embodiments of the present invention provide a turbocharger and booster system that does not suffer from the problems and limitations of the prior art turbochargers set forth above.

A first embodiment of the present invention concerns a turbocharged engine broadly including a reciprocating internal combustion engine, a turbocharger, and a turbocharger booster system. The reciprocating internal combustion engine includes an exhaust manifold configured to discharge engine exhaust flow and an intake manifold configured to supply intake air during engine operation. The turbocharger is operably coupled to the internal combustion engine and includes a turbine and compressor, with the turbine being configured to drive the compressor. The turbine is fluidly coupled to the exhaust manifold and configured to be powered by engine exhaust flow during engine operation. The compressor is fluidly coupled to the intake manifold and configured to discharge compressed air flow to the intake manifold. The turbocharger booster system includes a burner in fluid communication with the exhaust manifold and is operable to inject a combustion gas flow into the exhaust manifold to increase the temperature of the engine exhaust flow.

A second embodiment of the present invention concerns a method of operating a turbocharged internal combustion engine so as to increase the mass flow of compressed air supplied by the turbocharger compressor to the engine, with the engine discharging exhaust flow to the turbocharger turbine. The method broadly includes the step of injecting a combustion gas flow into the engine exhaust flow upstream of the turbine thereby increasing the energy available to the turbine and resulting in increased compressor rotational speed.

Other aspects and advantages of the present invention will be apparent from the following detailed description of the preferred embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is a schematic view of a turbocharged engine constructed in accordance with a preferred embodiment of the present invention, with the turbocharged engine including an intake assembly, an exhaust assembly, a turbocharger assembly, and a turbocharger booster system, and with the turbocharger booster system including a burner assembly, air control assembly, and fuel control assembly;

FIG. 2 is a schematic view of the air control assembly shown in FIG. 1;

FIG. 3 is a schematic view of the fuel control assembly shown in FIG. 1; and

FIG. 4 is a fragmentary perspective view of the turbocharged engine shown in FIG. 1, showing the intake assembly, exhaust assembly, and the turbocharger assembly, and showing the burner assembly fluidly coupled to an exhaust manifold of the exhaust assembly.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

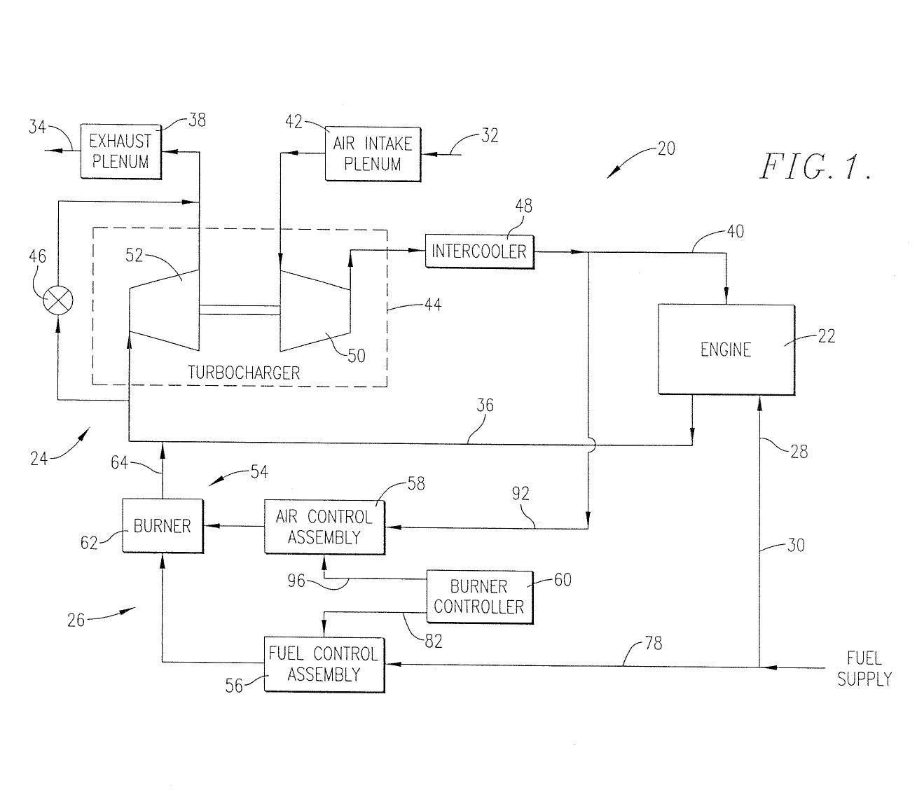

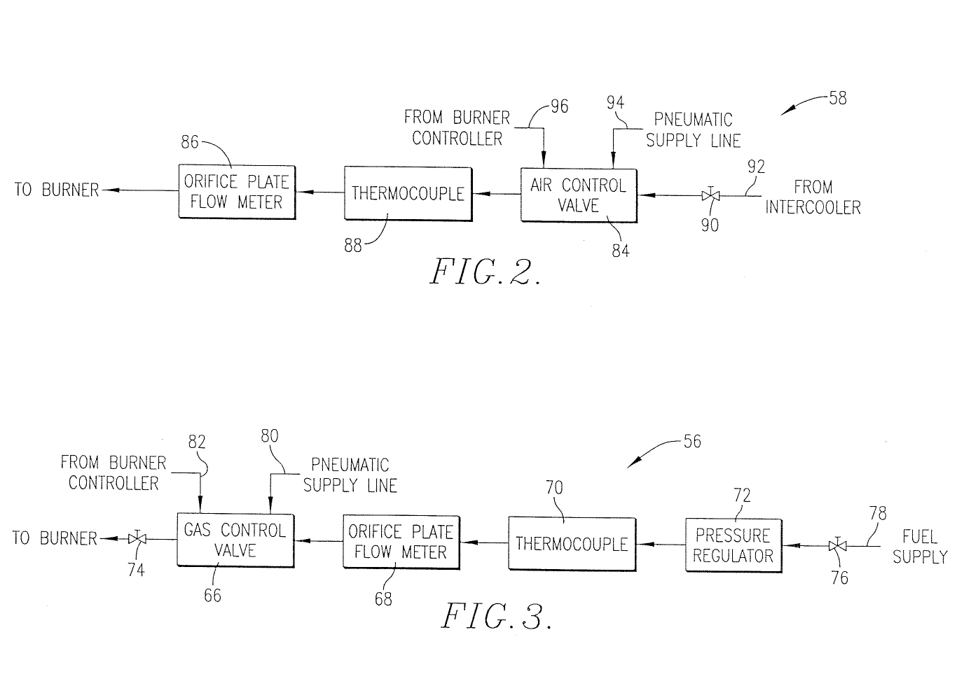

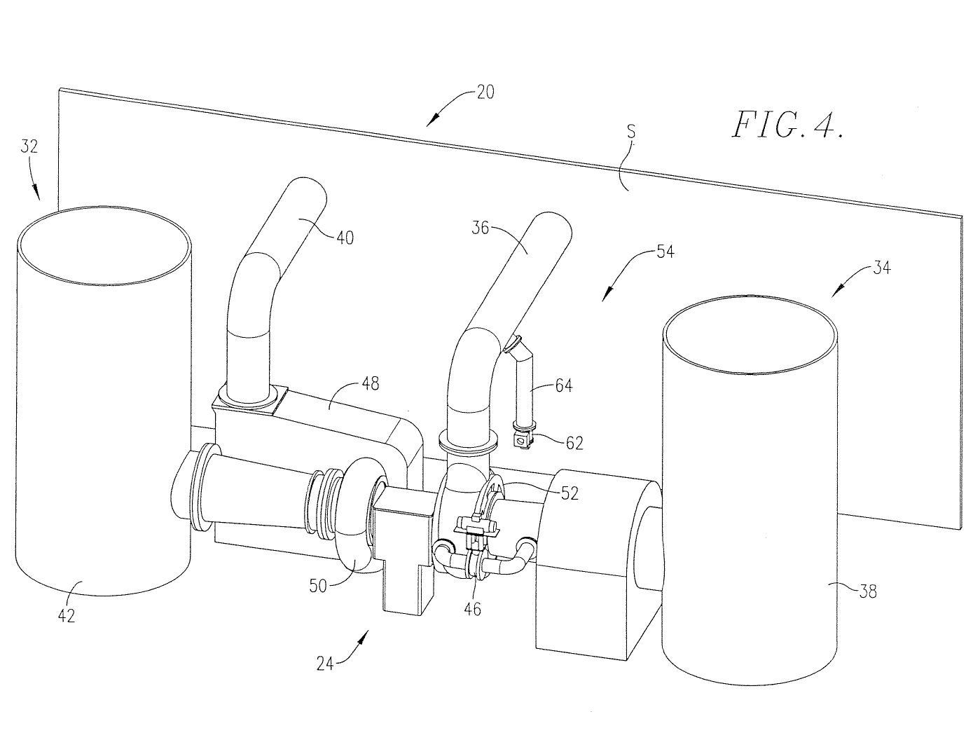

Turning initially to FIGS. 1 and 4, a turbocharged engine assembly 20 is installed adjacent a natural gas compressor station S and is operable to compress and transmit natural gas along a natural gas transmission line (not shown). The engine assembly 20 is particularly suited to operate efficiently while producing a minimal amount of harmful gas emissions, such as NO_{X} emissions, from engine operation. The illustrated engine assembly 20 is preferably used for gas transmission, but the principles of the present invention are applicable for other internal combustion engine applications, such as marine power, electricity generation, and other industrial power applications, that require an efficient and low-emission internal combustion engine. The turbocharged engine assembly 20 broadly includes an integral gas engine-compressor 22, a turbocharger assembly 24, and a turbocharger booster system 26.

Turning to FIG. 1, the integral gas engine-compressor 22 is fluidly coupled to the natural gas transmission line to compress and transmit natural gas. The illustrated integral gas engine-compressor 22 broadly includes a reciprocating two-stroke cycle engine and a gas compressor assembly (not shown). The two-stroke cycle engine is a conventional large-bore engine, i.e, an engine much larger than a conventional automotive engine, with a plurality of power cylinders (not shown) and serves to power the gas compressor assembly. The illustrated engine-compressor 22 is a Clark TLA10 integral engine, but could be another type of integral gas engine-compressor. Also, it is within the ambit of the present invention for the engine-compressor 22 to comprise a two-stroke cycle engine without a gas compressor. Furthermore, the principles of the present invention are equally applicable to four-stroke cycle engines as well as the illustrated two-stroke cycle engine.

The engine-compressor 22 also includes a gas fuel system 28 with gas injection valves (not shown) fluidly communicating with the power cylinders and a fuel supply line 30 that provides gas to the gas injection valves.

Furthermore, the engine-compressor 22 includes an intake assembly 32 and an exhaust assembly 34 that fluidly communicate with intake and exhaust ports of the power cylinders. The exhaust assembly 34 includes an exhaust manifold 36 and an exhaust plenum, with the exhaust manifold 36 being fluidly connected to and configured to receive engine exhaust from the power cylinders. The exhaust manifold 36 and exhaust plenum 38 are fluidly interconnected by the turbocharger assembly 24. As will be discussed further, engine exhaust is discharged from the cylinders into the exhaust manifold 36, with the exhaust powering the turbocharger assembly 24 and being discharged into the exhaust plenum 38.

The intake assembly 32 includes an intake manifold 40 and an intake plenum 42, with the intake manifold 40 fluidly connected to intake ports of the power cylinders. The intake manifold 40 and intake plenum 42 are fluidly interconnected by the turbocharger assembly 24, with intake air being configured to flow from the plenum 42, compressed by the turbocharger assembly 24, and discharged by the intake manifold 40 into the cylinders. The illustrated intake assembly 32 also includes intake runners (not shown) that each fluidly connect the intake manifold 40 and a corresponding one of the power cylinders.

The conventional engine combines intake air from the intake assembly 32 and fuel from the gas fuel system 28 in the cylinders to support combustion, with the air flow rate, the fuel flow rate, and the scavenging efficiency of each cylinder providing a trapped equivalence ratio φ. The trapped equivalence ratio φ is the ratio of the actual fuel-to-air ratio in the cylinder to the stoichiometric fuel-to-air ratio. Importantly, it has been determined that NO_{X} production is a function of trapped equivalence ratio φ. As will be discussed in greater detail, the present invention is configured to reduce trapped equivalence ratio φ.

The illustrated turbocharged engine assembly 20 may also include an intake balancing system (not shown) with valves operably mounted in the intake runners and configured to control air intake flow into the power cylinders. An exemplary intake balancing system and the benefits of such a system are shown and described in the above-incorporated U.S. Patent Application entitled ACTIVE AIR CONTROL. It is a principal function of the intake balancing system to balance trapped air mass among the cylinders to reduce trapped equivalence ratio φ and reduce NO_{X} emissions. However, the principles of the present invention are equally applicable where the turbocharged engine assembly 20 does not include the intake balancing system.

The turbocharger assembly 24 is configured to supply air intake flow into the engine-compressor 22 and is powered by exhaust flow from the engine-compressor 22. The turbocharger assembly 24 broadly includes a turbocharger 44, a turbine wastegate valve 46, and an intercooler 48. The wastegate valve 46 is fluidly connected to the exhaust manifold 36 at a location upstream of the turbocharger 44 and to a turbine exhaust nozzle located downstream of the turbocharger. In the usual manner, the wastegate valve 46 is configured to vent engine exhaust that is not needed to power the turbocharger 44.

In the usual manner, the illustrated turbocharger 44 includes a centrifugal compressor 50 and a turbine 52. The compressor 50 includes an impeller (not shown) and the turbine 52 includes a turbine rotor (not shown) drivingly connected to the impeller by a shaft and thereby configured to drive the impeller. The compressor 50 also includes a compressor case that rotatably receives the impeller. The compressor case presents an axial inlet that receives ambient air from the intake plenum 42 and a radial discharge that fluidly communicates with and discharges compressed air flow into the intercooler 48. However, the compressor 50 could be alternatively configured without departing from the scope of the present invention. For instance, the compressor 50 could discharge compressed air flow directly into the intake manifold 40. The compressor 50 operates with a ratio of discharge pressure over intake pressure, i.e., a pressure ratio, ranging from about 1.25 to about 3.0.

It has been discovered that the turbocharger 44 alone does not provide enough compressed air under certain conditions to develop a trapped equivalence ratio φ that results in low NO_{X} emissions, e.g., NO_{X} emissions of about 0.5 g/bhp-hr. One such condition typically occurs when the ambient air temperature is extremely high, e.g., during the summer months. For example, where the engine-compressor 22 and turbocharger 44 are designed to work under relatively cool conditions, e.g., standard temperature (68° F.) and pressure (14.696 psi), hot ambient temperatures, e.g., 100° F. or greater, result in a mass air flow rate into the engine less than the mass air flow rate at design conditions. Consequently, trapped equivalence ratio φ goes up during hot ambient conditions, with the engine-compressor 22 producing a high level of NO_{X} emissions.

The turbocharger 44 can also fail to provide enough compressed air to the engine-compressor 22 when the engine operator attempts to reduce trapped equivalence ratio φ in the power cylinders. A reduced trapped equivalence ratio φ can be achieved by increasing the mass air flow rate discharged by the turbocharger 44 into the engine-compressor 22. For example, mass air flow rate from the compressor can be increased initially by raising the turbocharger speed because the air flow rate through the compressor is approximately a linear function of compressor speed. Compressor speed can be increased by raising the amount of exhaust energy available to the turbine, e.g., by shifting the wastegate valve 46 from an open position to a closed position to divert more engine exhaust flow through the turbine. However, an increase in mass air flow rate reduces the engine exhaust temperature, which correspondingly reduces the amount of energy available to the turbocharger 44 from the engine exhaust. Consequently, the turbocharger 44 will not be able to maintain the initial increase in mass air flow rate.

The turbine 52 includes a turbine case that rotatably receives the turbine rotor. The turbine case presents a radial inlet that is configured to receive engine exhaust gases and an axial discharge through which the engine exhaust gases exit the turbine 52. However, it is also within the scope of the present invention where the turbine case is configured to have an axial inlet and a radial discharge. The inlet of the turbine 52 is fluidly attached to the exhaust manifold 36 and receives engine exhaust gases from the exhaust manifold 36. The illustrated turbocharger 44 may include variable compressor vane geometry that can be adjusted to permit efficient engine and turbocharger operation under a range of environmental conditions. An exemplary turbocharger utilizing variable compressor vane geometry and the benefits thereof are disclosed in greater detail in the above-incorporated U.S. Patent Application entitled VARIABLE GEOMETRY TURBOCHARGER.

While the illustrated turbocharger 44 is preferred, a conventional turbocharger could be used with the engine-compressor 22, or another type of supercharger could be used, such as a blower driven by the engine crankshaft. Also, the principles of the present invention are applicable where the engine-compressor 22 is not provided with a turbocharger, or where multiple turbochargers supply compressed air to the engine-compressor 22. In particular, multiple turbochargers could be configured to provide the desired amount of compressed air to the engine-compressor 22.

The turbocharger booster system 26 is operably coupled to the turbocharger 44, with the booster system 26 and turbocharger 44 being operable to selectively supply compressed air to the engine-compressor 22. The booster system 26 broadly includes a burner assembly 54, a fuel control assembly 56, an air control assembly 58, and a burner controller 60. The burner assembly 54 includes a burner 62 and a burner tube 64 that fluidly connects the burner 62 to the exhaust manifold 36. The illustrated burner 62 is preferably a dry low emissions (DLE) burner that combusts natural gas provided by the fuel control assembly 56 and discharges a hot combustion gas flow, with the burner 62 producing less than about 0.2 g/bhp-hr of NO_{X}. However, other types of burners could be used without departing from the scope of the present invention. Also, the burner 62 preferably is operable to increase the temperature of engine exhaust flow by at least about 200° F. An exemplary burner that may be used with the present invention is a ThermJet nozzle-mix burner, Model No. FJ200, manufactured by Eclipse, Inc. of Rockford, Ill. Surprisingly, it has been found that varying the equivalence ratio of the burner 62 affects the amount of carbon monoxide (CO) emissions produced by the burner 62 and engine combination, but has essentially no effect on NO_{X} emissions produced by the combination, as will be discussed further.

The burner tube 64 is preferably made of stainless steel and presents a length of about three (3) feet from end-to-end. The illustrated burner tube 64 is installed with one end attached to the exhaust manifold 36 and extends below the exhaust manifold 36, with the other end attached to the burner 62. The length of the burner tube 64 preferably restricts a combustion flame discharged by the burner 62 from directly contacting the exhaust manifold. In particular, the maximum flame length for burner 62 is about three (3) feet. However, it is within the scope of the present invention where the burner tube 64 has an alternative length, e.g., where the burner tube 64 is longer than three feet. Also, the burner tube 64 could be alternatively positioned relative to the exhaust manifold 36. For example, the burner tube 64 could extend upwardly from the exhaust manifold 36 so that any condensation in the burner tube 64 would fall away from the burner 62. Furthermore, burner 62 could be directly attached to the exhaust manifold, i.e., without using the burner tube 64, to inject the hot combustion gas flow. Yet further, the burner 62 could be attached to another location, e.g., adjacent the turbine inlet, to inject hot combustion gas flow upstream of the turbine 52, as will be discussed further.

The fuel control assembly 56 includes a gas control valve 66, a flow meter 68, a thermocouple 70, a pressure regulator 72, and manual flow valves 74,76 fluidly connected in series along a burner fuel supply line 78. The flow meter 68 preferably comprises an orifice plate meter, but other types of fluid flow meters could be used. The gas control valve 66 is preferably a normally-closed, pneumatically actuated valve and, more preferably, is a TRIAC Model valve manufactured by A-T Controls, Inc. of Cincinnati, Ohio. The gas control valve 66 is preferably actuated by high-pressure air supplied by pneumatic line 80. However, the gas control valve 66 could include an alternative actuator, such as an electrical motor, without departing from the scope of the present invention. The gas control valve 66 is operably coupled to the burner controller 60 by a signal line 82 that transmits a 4-20 milliamp signal to selectively meter a natural gas flow to the burner 62.

The air control assembly 58 includes an air control valve 84, a flow meter 86, a thermocouple 88, and a manual flow valve 90 fluidly connected in series along a combustion air supply line 92. The flow meter 86 preferably comprises an orifice plate meter, but other types of fluid flow meters could be used. The combustion air supply line 92 fluidly interconnects the burner 62 and the intake manifold 40 and is preferably attached to the intake manifold 40 downstream of the intercooler 48 to receive compressed air flow from the compressor 50. However, the principles of the present invention are applicable where the combustion air supply line 92 is attached to the intake manifold 40 upstream of the intercooler 48. Furthermore, the combustion air supply line 92 could receive compressed air flow from a source of compressed air other than the compressor 50, e.g., an auxiliary blower driven by the engine-compressor 22 or by another power source.

The air control valve 84 is preferably a normally-closed, pneumatically actuated valve and, more preferably, is a TRIAC Model valve manufactured by A-T Controls, Inc. of Cincinnati, Ohio. The air control valve 84 is preferably actuated by high-pressure air supplied by pneumatic line 94. However, the air control valve 84 could include an alternative actuator, such as an electrical motor, without departing from the scope of the present invention. The air control valve 84 is operably coupled to the burner controller 60 by a signal line 96 that transmits a 4-20 milliamp signal to selectively meter compressed air flow to the burner 62.

Preferably, fuel control assembly 56 and air control assembly 58 supply respective fuel and air flows that are combined at the burner 62 for combustion and cooperatively provide a substantially stoichiometric mixture of air and fuel for combustion. However, it is also within the scope of the present invention where a lean air-and-fuel mixture is combusted. In this manner, the burner 62 ignites the mixture and discharges the hot combustion gas flow into the burner tube 64 and into the exhaust manifold 36 so that the hot combustion gas flow mixes with the engine exhaust flow to increase the amount of exhaust energy available to the turbine 52. In particular, the combustion gas flow increases the temperature of the engine exhaust flow, preferably by at least about 200° F. However, alternative configurations of the burner assembly 54 could be used to inject the hot combustion gas flow into the engine exhaust flow upstream of the turbine 52. For example, the burner 62 could be positioned to inject hot combustion gas flow adjacent the turbine inlet.

As discussed previously, it has been unexpectedly found that varying the equivalence ratio of the burner 62 affects the amount of carbon monoxide (CO) emissions produced by the burner 62 and engine combination, but has essentially no effect on NO_{X} emissions produced by the combination. It is believed that the temperature of engine exhaust flow, e.g., about 900° F., restricts NO_{X} formation in the combustion gas flow as the combustion gas flow is injected into the engine exhaust flow.

The illustrated turbocharger booster system 26 is configured to selectively power the turbocharger 44 to increase the compressed air output of the turbocharger 44 and lower trapped equivalence ratio φ, particularly where adjustment of the wastegate valve 46 or the engine-compressor 22 is unable to increase compressed air output. It has been discovered that a compressor pressure ratio ranging from about 2.4 to about 3.0 is necessary to provide NO_{X} emissions of about 0.5 g/bhp-hr. Because the burner is capable of boosting turbocharger performance to achieve such a pressure ratio, along with the required mass flow rate, it has been found that the booster system 26 is particularly effective for increasing compressed air output when the ambient air temperature is extremely high, e.g., during the summer. Furthermore, the booster system 26 is operable to increase compressed air output when the engine-compressor 22 delivers a reduced amount of exhaust energy to the turbocharger 44, e.g., when the engine operates under lean conditions and discharges exhaust flow with a correspondingly reduced exhaust temperature. Yet further, the booster system 26 is configured to overcome reduction in compressed air output due to degradation in turbocharger performance, e.g., because of turbocharger component wear. In this manner, the illustrated booster system 26 serves to broaden the operating range of the engine-compressor 22 and, importantly, permits the turbocharger 44 to be operated independent of engine operating conditions and ambient conditions.

The booster system 26 also is configured to improve cold weather start-up of the turbocharged engine assembly 20. It has been found that the engine-compressor 22 and turbocharger 44 may require a significant amount of time to reach steady-state operating conditions (e.g., operating temperature) during engine start-up, particularly during cold ambient conditions. In greater detail, the illustrated exhaust manifold 36 and turbocharger 44 are positioned outside of station S and will cool to ambient temperature when the engine is shut-off for an extended period of time. The engine assembly 20 is started by initially spinning the turbocharger impeller up to a predetermined speed with an air assist device (not shown) that uses compressed air from the station S, and the engine-compressor 22 is also started. However, it has been found that the engine exhaust slowly heats up the manifold 36, such that air assist normally must be used one or more times to maintain impeller speed after the impeller is initially brought up to speed by the air assist. The booster system 26 is operable during start-up to add heat to the exhaust manifold 36 and turbocharger 44. In particular, the heat provided by the booster system 26 cooperates with the engine exhaust to quickly bring the manifold 36 and turbocharger 44 up to operating temperature. In this manner, the booster system 26 is configured to minimize the use of the air assist device once the impeller is initially brought up to speed.

While the illustrated booster system 26 is preferred, the principles of the present invention are applicable where other turbocharger boosting devices are used to increase the compressed air output and thereby reduce trapped equivalence ratio φ and NO_{X} emissions. For instance, a chiller (not shown) could be installed upstream of the compressor intake to lower the temperature of incoming air and thereby increase the mass flow rate of air drawn into the compressor 50. Also, an auxiliary compressor (not shown) could be installed upstream of the compressor intake to increase the pressure of incoming air and thereby increase the mass flow rate of air drawn into the compressor 50. Furthermore, any combination of the booster system 26, chiller, and auxiliary compressor could be used to increase the compressed air output of the turbocharger 44. Preferably, the illustrated turbocharged engine assembly 20 produces NO_{X} emissions that range from about 0.45 g/bhp-hr to about 0.80 g/bhp-hr. More preferably, the turbocharged engine assembly 20 produces about 0.50 g/bhp-hr of NO_{X}. However, the principles of the present invention are applicable where NO_{X} emissions lie outside of these values.

In operation, the engine-compressor 22 operates to transmit natural gas along the transmission line. Various engine operating conditions, such as ambient air temperature or NO_{X} emissions, may be determined by the operator when necessary. For instance, the operator may determine NO_{X} by determining trapped equivalence ratio φ. As additional compressed air is required by the engine-compressor 22 to continue operating at the sale engine load or engine speed without producing more NO_{X} emissions, the controller 60 is used to operate the burner 62 and supply the hot combustion gas flow so as to increase the exhaust energy available to the turbocharger turbine 52. Consequently, the turbine 52 spins the compressor 50 at a higher speed and causes an increased air mass flow rate to be supplied to the engine-compressor 22 to maintain a desired level of trapped equivalence ratio φ or NO_{X} emissions.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

What is claimed is:

1. A turbocharged engine comprising:
a reciprocating internal combustion engine including an exhaust manifold configured to discharge engine exhaust flow and an intake manifold configured to supply intake air during engine operation;
a turbocharger operably coupled to the internal combustion engine and including a turbine and compressor, with the turbine being configured to drive the compressor,
said turbine fluidly coupled to the exhaust manifold and configured to be powered by engine exhaust flow during engine operation,
said compressor fluidly coupled to the intake manifold and configured to discharge compressed air flow to the intake manifold; and
a turbocharger booster system including a burner in fluid communication with the exhaust manifold and operable to inject a combustion gas flow into the exhaust manifold to increase the temperature of the engine exhaust flow.

2. The turbocharged engine as claimed in claim 1,
said burner comprising a dry low emissions burner having a NO_{X} production rate of less than about 0.2 g/bhp-hr.

3. The turbocharged engine as claimed in claim 2,
said turbocharger booster system including a burner tube that fluidly interconnects the burner and the engine exhaust manifold and is configured to transmit combustion gas flow into the engine exhaust manifold.

4. The turbocharged engine as claimed in claim 3,
said burner tube presenting opposite ends, with one end being attached to the engine exhaust manifold and the other end being attached to the burner,
said burner tube extending from the engine exhaust manifold.

5. The turbocharged engine as claimed in claim 2,
said burner being operable to inject the combustion gas flow and thereby increase the temperature of engine exhaust flow by at least about 200° F.

6. The turbocharged engine as claimed in claim 1,
said turbocharger booster system including a fuel system that fluidly communicates with the burner and is configured to supply fuel flow to the burner for combustion, with the booster system being operable to power the turbocharger independently of internal combustion engine operation.

7. The turbocharged engine as claimed in claim 6,
said fuel system including a fuel control valve in fluid communication with the burner and configured to meter the fuel flow to the burner.

8. The turbocharged engine as claimed in claim 1,
said turbocharger booster system including an air system that fluidly communicates with the burner and is configured to supply combustion air flow to the burner for combustion.

9. The turbocharged engine as claimed in claim 8,
said air system in fluid communication with the compressor and configured to draw combustion air flow from the compressed air flow discharged by the compressor.

10. The turbocharged engine as claimed in claim 8; and
an intercooler in fluid communication with the intake manifold,
said compressor including a compressor discharge in fluid communication with the intercooler, with compressed air flow being operable to travel from the compressor to the intake manifold by passing through the intercooler,
said combustion air flow being drawn from compressed air flow discharged from the intercooler.

11. The turbocharged engine as claimed in claim 8,
said air system including an air control valve in fluid communication with the burner and configured to meter the combustion air flow to the burner for combustion independent of internal combustion engine operation.

12. The turbocharged engine as claimed in claim 8,
said turbocharger booster system including a fuel system that fluidly communicates with the burner and is configured to supply fuel flow to the burner for combustion, with the booster system being operable to power the turbocharger independently of internal combustion engine operation,
said fuel system including a fuel control valve in fluid communication with the burner and configured to meter the fuel flow to the burner,
said turbocharger booster system including a controller operably coupled to the control valves, with the controller configured to operate the control valves to provide a substantially stoichiometric mixture of combustion air flow and fuel flow.

13. A method of operating a turbocharged internal combustion engine so as to increase the mass flow of compressed air supplied by the turbocharger compressor to the engine, with the engine discharging exhaust flow to the turbocharger turbine, said method comprising the step of:
(a) injecting a combustion gas flow into the engine exhaust flow upstream of the turbine thereby increasing the energy available to the turbine and resulting in increased compressor rotational speed.

14. The method as claimed in claim 13,
step (a) including the step of increasing the temperature of engine exhaust flow by at least about 200° F.

15. The method as claimed in claim 13; and
(b) sensing a changed condition associated with engine operation and performing step (a) in response thereto.

16. The method as claimed in claim 15,
step (b) including the step of sensing an increase in ambient air temperature.

17. The method as claimed in claim 15,
step (b) including the step of determining an increase in NO_{X} emissions from the engine.

18. The method as claimed in claim 13,
(b) increasing the mass flow rate of ambient air into the compressor.
